(19) United States
(12) Patent Application Publication
(10) Pub. No.: US 2014/0017630 A1
(43) Pub. Date: Jan. 16, 2014

(54) Dental Polisher

(71) Applicant: Paul R. Chalifoux, Wellesley, MA (US)

(72) Inventor: Paul R. Chalifoux, Wellesley, MA (US)

(21) Appl. No.: 14/028,211

(22) Filed: Sep. 16, 2013

Related U.S. Application Data
(63) Continuation-in-part of application No. 13/374,107, filed on Dec. 13, 2011, now abandoned.

(51) Int. Cl. A61C 3/06

(52) U.S. Cl. CPC A61C 3/06
USPC 433/166

(57) ABSTRACT

A dental polisher is provided comprising a cup, finger projections positioned within the cup and a drill attachment on the cap for attaching the cup to a dental drill. The finger projections and the rim of the cup are formed of abrasive materials. The cup may contain a polishing material.

### CROSS REFERENCE TO RELATED APPLICATION

This application is a Continuation-In-Part application and claims priority to and takes the benefit of U.S. patent application Ser. No. 13/374,107 filed on Dec. 13, 2011, the contents of which are herein incorporated by reference.

### BACKGROUND OF THE INVENTION

1. Field of the Invention

This invention relates to a dental polisher used to polish dental restorations. More particularly, this invention relates to a dental polisher using a single polishing head to polish the entire dental restoration.

2. Description of the Related Art

Presently, dental restorations such as composite, gold, porcelain, acrylics, bisacrylic and the like are used to restore lost tooth structure on a temporary or permanent basis. Teeth are prepared and filling material is placed on the dental cavity and it is then shaped. This procedure leaves a rough surface that needs to be polished. The restoration is then polished to effect smooth restoration surfaces. Presently, polishing is accomplished by a series of polishers to fit into various convex, concave and flat surfaces. Polishers include burs, disks, cups, points, brushes or cloth which may be combined with polishing pastes to complete the desired polishing. Convexities and concavities on tooth surfaces may be as large as the total tooth size or very small as occurs in grooves, pits and surface texturing.

Presently available polishers have the disadvantage that a number of finishers having different shapes are necessary, which, in view of their shape, merely can be used for one predetermined operation step of an entire operation procedure or an entire finishing process. They are used one after the other until the treatment of finishing operation has been completed. This process requires a time consuming change on the dental instrument and added cost.

Accordingly, it would be desirable to provide a dental polisher capable of polishing all of the contours of the teeth of a dental restoration in order to effect minor shaping and complete polishing. Such a polisher would eliminate the need for time consuming head changing of dental polisher heads and the added cost of using several polishers.

### SUMMARY OF THE INVENTION

In accordance with this invention, a dental polisher is provided which comprises a cup, a single or plurality of finger projections placed within a cup and an attachment arm attached to the outside surface of the cup. The cup attachment arm can be connected to a dental drill which rotates the cup during its use.

### BRIEF DESCRIPTION OF THE DRAWINGS

FIG. 1 is an isometric view of the dental polisher of this invention. FIG. 1A is a partial breakaway view of the polisher of FIG. 1.

FIG. 1B is a side view of a baton which is utilized in the polisher of FIG. 1.

FIG. 2 shows different alternative configurations of finger projections (points) that can be utilized in the cup of FIG. 1.

FIG. 3 illustrates the use of the polisher of FIG. 1 on all surfaces of back teeth.

FIG. 4 illustrates the use of the polisher of FIG. 1 on all surfaces of front teeth.

FIG. 5 shows the polisher cup filled with uniform polishing material.

FIG. 5A shows the polisher cup filled with two different types of polishing material, the bottom layer for coarse polishing and the top layer for fine polishing.

FIG. 5B shows the polisher cup filled with polishing paste.

FIG. 6 shows an alternative polisher of this invention.

FIG. 6A is a partial breakaway view of the polisher of FIG. 6.

FIGS. 7A and 7B illustrate an alternative embodiment of the dental polisher system.

FIGS. 8A and 8B illustrate an alternative embodiment of the dental polisher system.

### DETAILED DESCRIPTION OF THE PREFERRED EMBODIMENTS

In accordance with this invention, a dental polisher is provided which comprises a cup, a plurality of finger projections {points) placed within the cup and an arm attached to the cup. During use, the cup is connected to a dental drill so that the cup and finger projections can be rotated. The cup can contain a polishing composition which can contain an abrasive or have an abrasive incorporated into it.

The cup is sufficiently flexible so that it can conform to the various contours of front and back surfaces of a tooth during use. The finger projections fit into the contours on the top of the tooth. The exposed surfaces of the finger projections and the exposed cup rim can contain an abrasive composition. Thus, the apparatus of this invention is capable of polishing the entire exposed surface of a tooth.

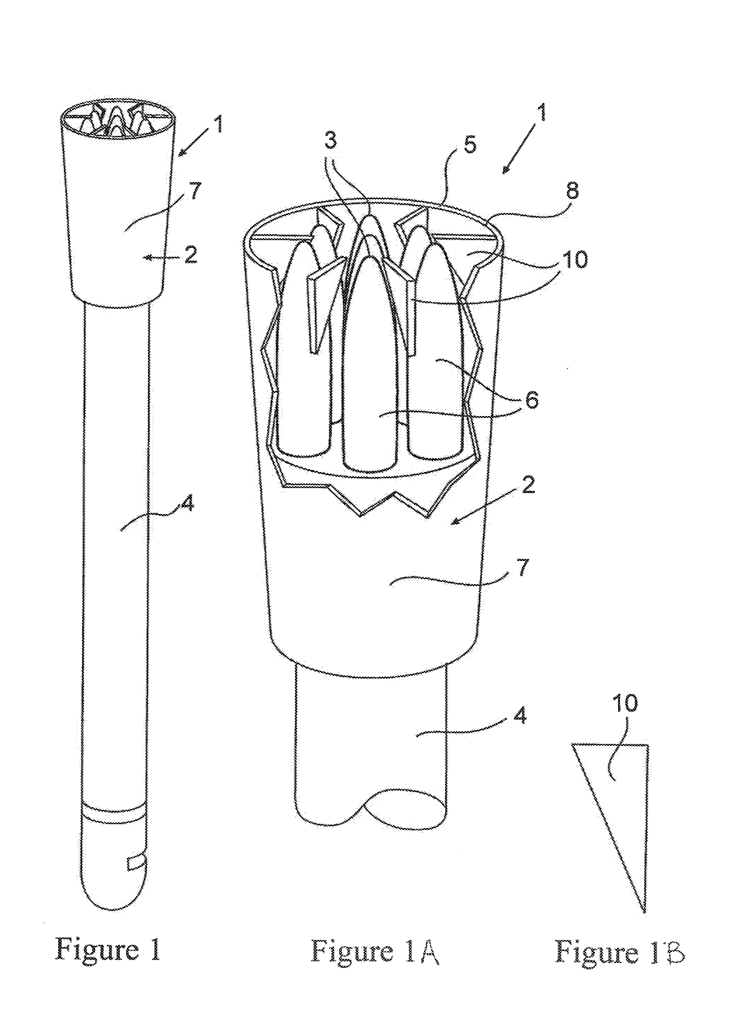

Referring to FIGS. 1, 1a, and 1b, the dental polisher 1 of this invention comprises a cup 2 having a wall 7 attached to an attachment arm 4 which, in turn, fits into a conventional dental drill (not shown). Finger projections 6 are attached to and fit within cup 2. The top surfaces 3 of finger projections 6 have substantially the same height as the top surface 8 the rim 5 of the cup 2 when the cup 2 is not flexed or may be slightly below. Finger projections 6 follow contours of teeth as a drill turns the polisher 1. Finger projections can include polishing material (abrasive) such as pumice or oxides incorporated into them to aid in polishing. Finger projections can have a variety of shapes from pointed, rounded, square, and triangular by fine polishing. Finger projections can be one point or many small points such that the points are brush like. The rim 5 of the cup 2 follows contours such as flat surfaces, outer and inner marginal ridges or along fine groove areas such that they are all polished. Wings 10 aid in polishing flat surfaces by having their flat surfaces contact a tooth as cup 2 rotates.

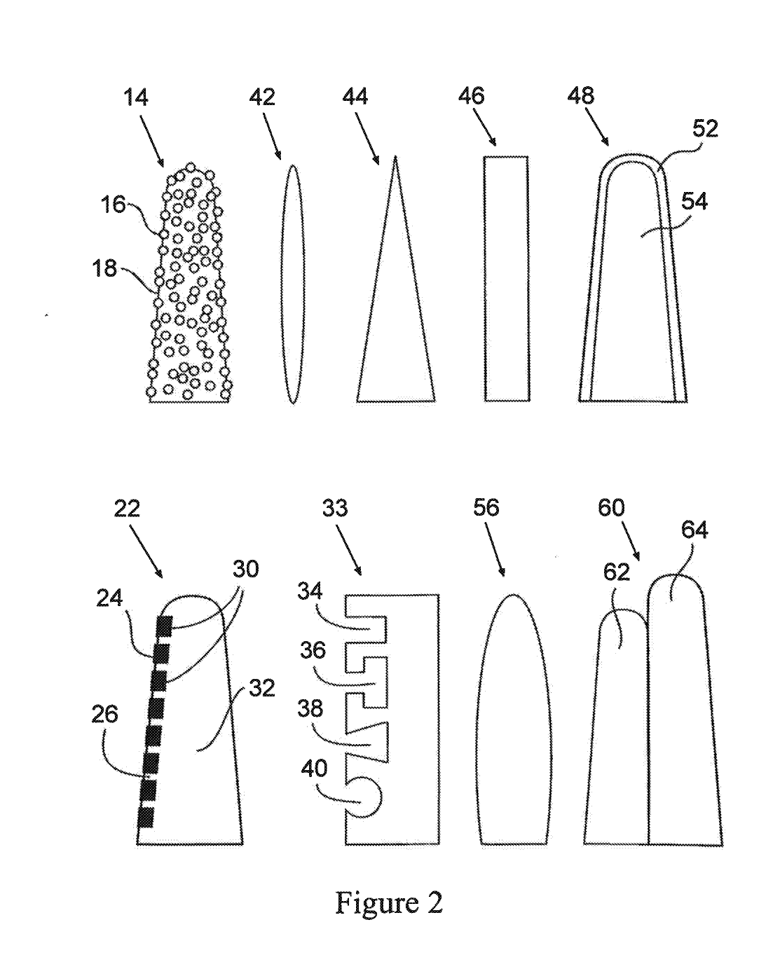

Referring to FIG. 2, a variety of suitable finger projections 6 for the cup 2 (FIG. 1) are shown. Finger projections 6 may be the same material as the cup or a different material. Finger projections 14 consist of polishing material 16 such as pumice, oxides, diamond pastes or the like which adheres to substructure 18. Finger projections 22 consist of polishing material 24 such as a paste which is placed into holes 30 between polishing projections 26 held in position by polishing substructure 32. As the polisher spins, paste 24 and projections 26 provide a coarse polish and wear away to reveal fine polishing substructure 32. Optional shapes used to hold polishing paste in points 33 are shown as square 34, internal rectangle 36, triangle 38 and round 40. Finger projections 42 shows a narrow point. Finger projections 44 shows a fine triangle point. Finger projections 46 shows a rectangular point. Finger projections 48 shows a dual layer point including outer coarse polishing layer which wears away to fine polishing layer 54. Finger projections 56 shows an oblong point. Finger projections 60 shows a dual point consisting of a coarse polishing side 62 and a fine polishing side 64.

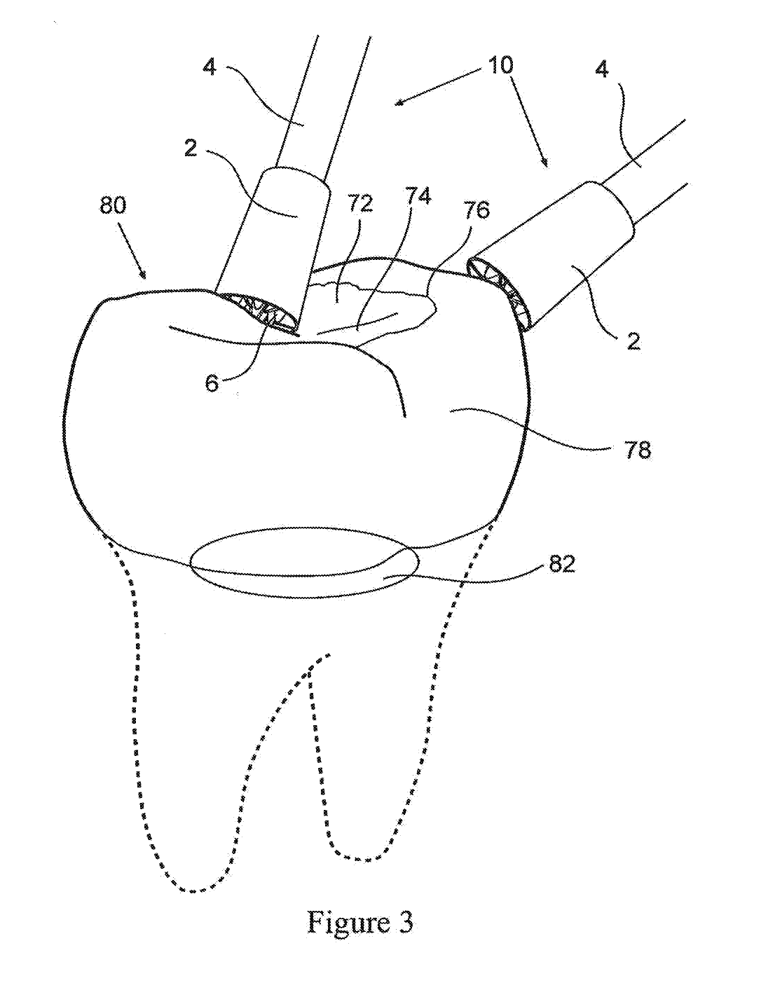

Referring to FIG. 3, a polisher 10 (of finger 1) with finger projections 6, wings 10 and cup 2 glide over cusp incline and secondary grooves 72, central and major grooves 74, marginal ridge 76, outer surface 78 and class 5 areas 82 of tooth 80. The polisher contacts all areas for Class 1, Class 2 and Class 5 fillings on back teeth.

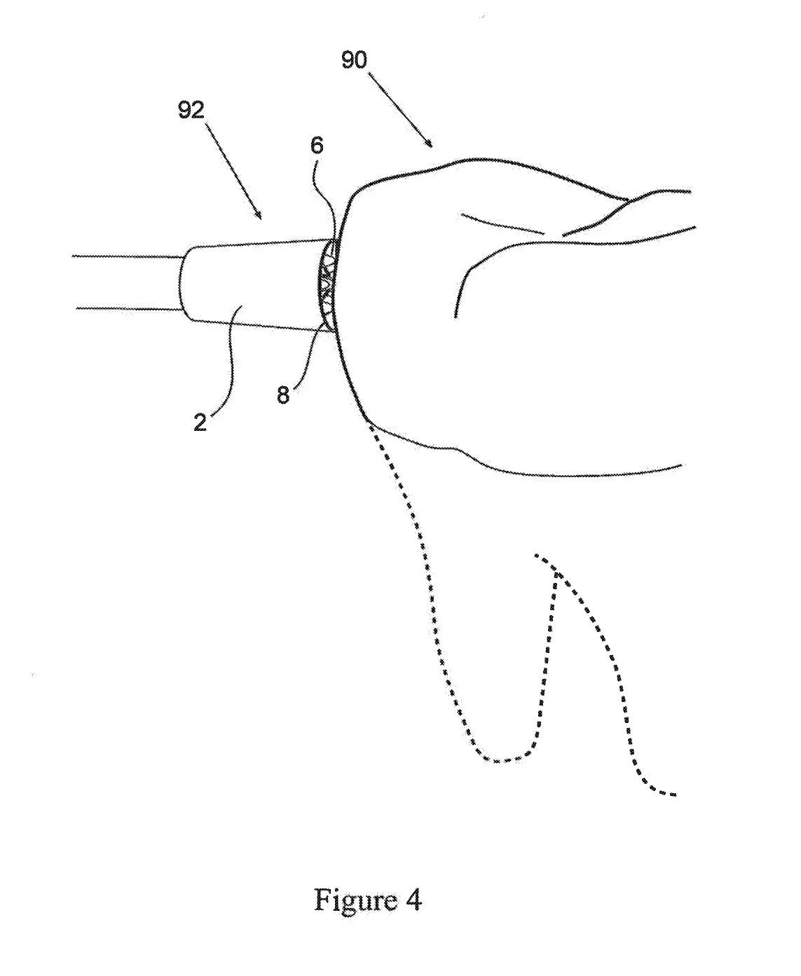

Referring to FIG. 4, a polisher 92 is shown polishing the front surface 90 of a tooth. Fine detail on tooth 90 referred to as surface textures is maintained as finger projections 6 glide in and out of fine detail while not reshaping it. The rim 8 of the cup 2 smoothes on surfaces and interproximal areas, the areas between teeth, to polish veneers, and class three, class four and class five fillings on front teeth.

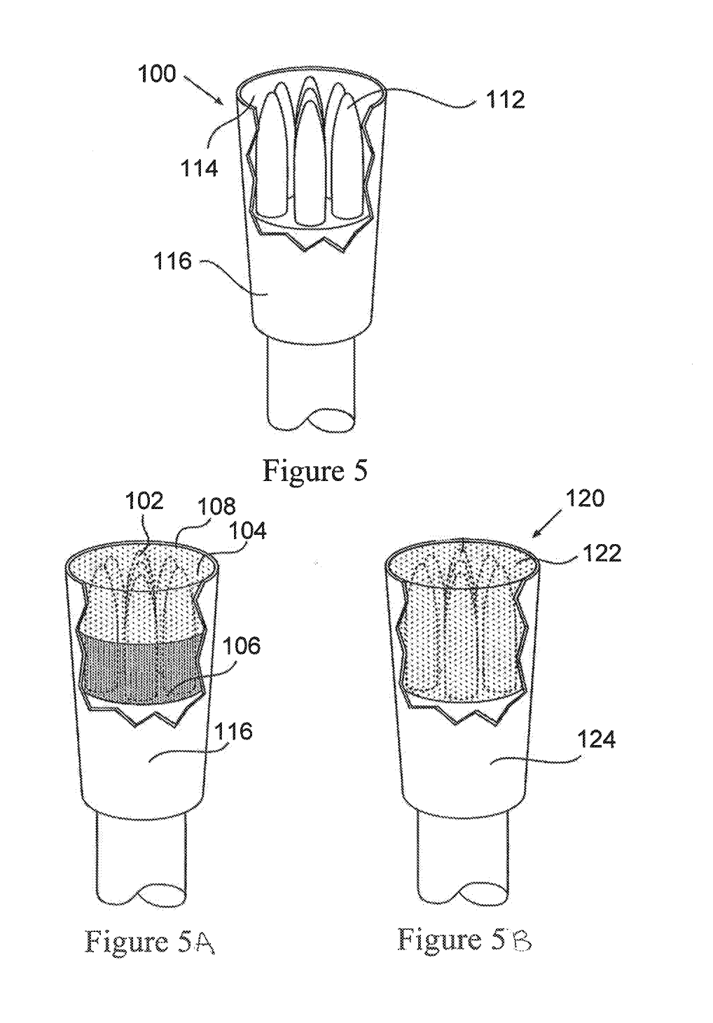

Referring to FIG. 5, polisher 100 which consists of finger projections 102 and cup 108. In cup 108 and between finger projections 102 is polish material 104 for coarse polishing and a second layer of polish material 106 for fine polish. Rotation of polisher 100 first allows polishing with material 104 followed by polishing with material 106. Polisher 100 consists of finger projections 112 and uniform polishing material 114 positioned within cup 116. Polisher 120 consists of cup 124 and polishing paste 122 as well as finger projections (not shown).

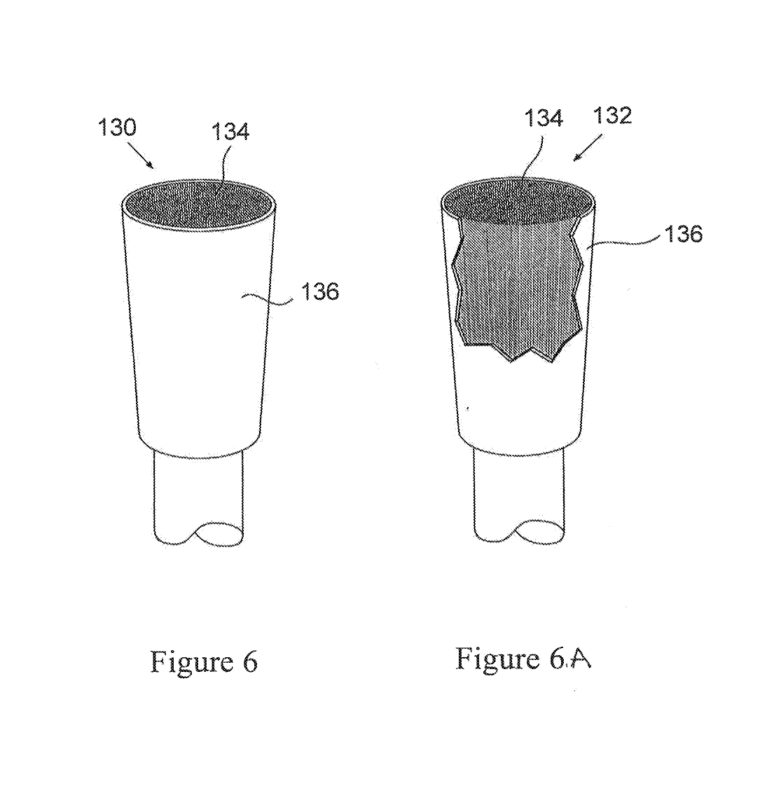

Referring to FIG. 6 and FIG. 6a, polisher 130 and cut away section of the polisher 132 are shown. The polishers 130 and 132 which contain many fine finger projections 134 in cup 136. Cup 136 may contain polishing paste or other polishing materials while finger projections 134 glide over surfaces to polish. The polishers 130 and 132 can be used either with or without paste. Many finer finger projections 134 provide a finer polish into finer areas than larger points.

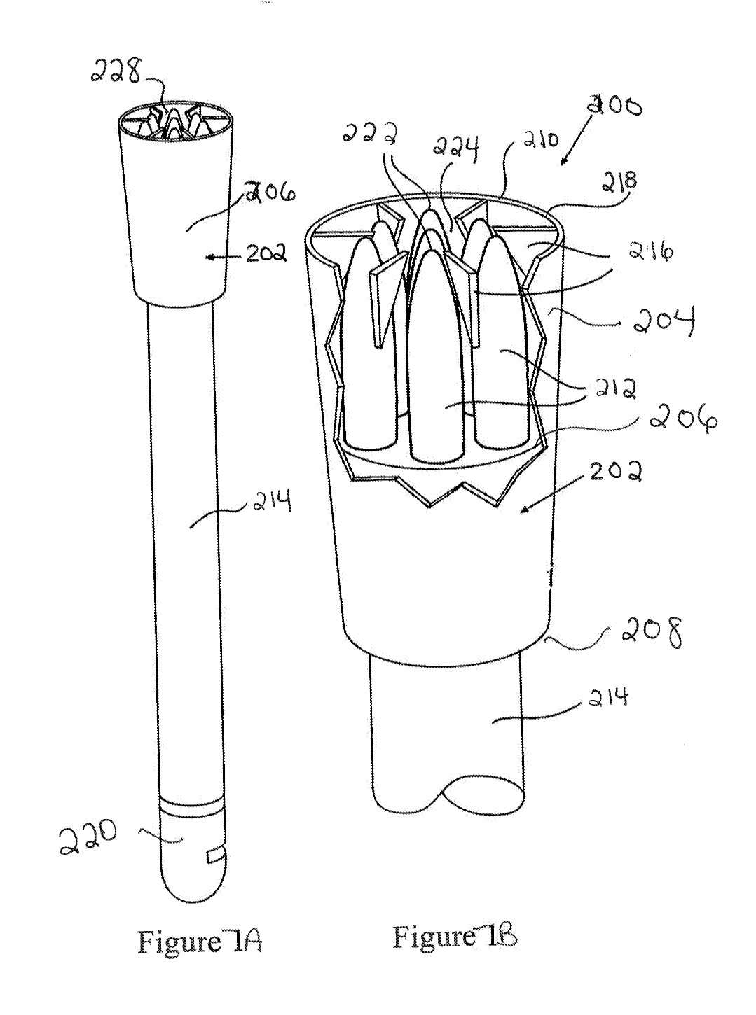

Referring to FIG. 7A and FIG. 7B, in an alternative embodiment, a dental polishing system 200 is shown comprising a substantially cylindrical retainer mechanism 202, comprising an upper portion 204, a median portion 206 and a lower portion 208, wherein the upper portion 204 comprises a substantially rigid rim portion 210. The dental polishing system 200 further comprises at least two projection mechanisms 212 in mechanical communication with the substantially cylindrical retainer mechanism 202, wherein the at least two projection mechanisms 212 extend upward from the lower portion 208 of the substantially cylindrical retainer mechanism 202 wherein the at least two projection mechanisms 212 extend substantially flush with the rim 210 of the substantially cylindrical retainer mechanism 202 and wherein the at least two projections mechanisms 212 are flexible to follow surface contours simultaneously with said rim 210 during use. Furthermore, an actuation arm 214 is in communication with the substantially cylindrical retainer mechanism 202 wherein the actuation arm 214 extends through the lower portion 208 of the substantially cylindrical retainer mechanism 202.

Additionally, the dental polishing system 200 includes the at least two projection mechanisms 212 and the rim 210 of the substantially cylindrical retainer mechanism 202 which comprise an abrasive composition. In another embodiment, the dental polishing system 200 further comprises at least one divider mechanism 216 extending radially inward from an interior portion 218 of the upper portion 204 of the substantially cylindrical retainer mechanism 202. The dental polishing system 200 allows for the median portion 206 and the lower portion 208 of the substantially cylindrical retainer mechanism 202 to be substantially flexible. The dental polishing system 200 wherein the lower portion 208 of the actuation arm 214 comprises an area for communication with a rotary motion mechanism 220.

In yet another embodiment, the dental polishing system 200 includes the substantially cylindrical retainer mechanism 202 which comprises a plurality of abrasive members 222 attached to an inner portion 224 of the substantially cylindrical retainer mechanism 202. Furthermore, the two projection mechanisms 212 are attached to the upper portion 204 of the actuation arm 214. Additionally, the substantially cylindrical retainer mechanism 202 comprises an abrasive composition 226 positioned within the substantially cylindrical retainer mechanism 202. In another embodiment, the at least one divider mechanism 216 is substantially triangular. In another embodiment, the at least two projection mechanisms 212 comprise at least one groove shape 228 for retaining polishing mixtures. Also, the at least one groove shape 228 for retaining polishing mixtures may be selected form the group consisting of a square, an internal rectangle, a triangle and a round. In another embodiment, the at least one divider mechanism 216 comprises a range of two to ten dividers. In another embodiment, the at least two projection mechanisms 212 comprise a range from three to twenty projection mechanisms.

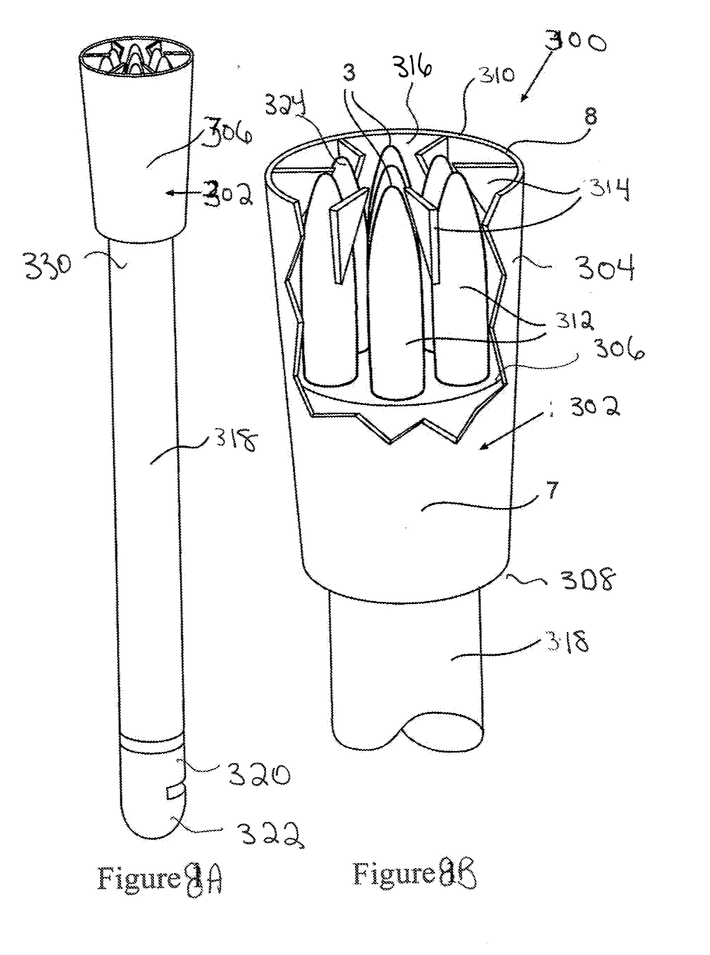

Referring to FIGS. 8A and 8B, in yet another embodiment, a dental polishing apparatus 300 is shown comprising a cup mechanism 302, comprising an upper portion 304, a median portion 306 and a lower portion 308, wherein the upper portion 304 comprises a substantially rigid rim portion 310. Furthermore, there are at least two finger mechanisms 312 in mechanical communication with the cup mechanism 302, wherein the at least two finger mechanisms 312 extend upward from the lower portion 308 of the cup mechanism 302 and wherein the at least two finger mechanisms 312 extend substantially flush with the rim 310 of the cup mechanism 302 and wherein the at least two finger mechanisms 312 are flexible to follow surface contours simultaneously with said rim 310 during use.

Additionally, at least one wing mechanism 314 extends radially inward from an interior portion 316 of the upper portion 304 and middle portion 306 of the cup mechanism 302 and, an attachment arm 318 is in communication with the cup 302 wherein the attachment arm 318 extends through the lower portion 308 of the cup 302. In one embodiment, the median portion 306 and the lower portion 308 of the cup mechanism 302 are substantially flexible. Also, the lower portion 308 of the attachment arm 318 comprises an area 320 for communication with a rotary motion mechanism 322. The cup mechanism 302 further comprises a plurality of abrasive members 324 attached to an inner portion 326 of the cup mechanism 302.

In yet another embodiment, the at least two finger mechanisms 312 are attached to the upper portion 330 of the attachment arm 318. Additionally, the cup mechanism 302 comprises an abrasive composition 332 positioned within the cup mechanism 302. Moreover, at least one wing mechanism 314 is substantially triangular. Lastly, the at least two finger mechanisms 312 comprise at least one groove shape 334 for retaining polishing mixtures.

What is claimed is:

1. A dental polishing system comprising:
a substantially cylindrical retainer mechanism, comprising an upper portion, a median portion and a lower portion, wherein the upper portion comprises a substantially rigid rim portion;
at least two projection mechanisms in mechanical communication with the substantially cylindrical retainer mechanism, wherein the at least two projection mechanisms extend upward from the lower portion of the substantially cylindrical retainer mechanism wherein the at least two projection mechanisms extend substantially flush with the rim of the substantially cylindrical retainer mechanism wherein the at least two projections mechanisms are flexible to follow surface contours simultaneously with said rim during use; and,
an actuation arm in communication with the substantially cylindrical retainer mechanism wherein the actuation arm extends through the lower portion of the substantially cylindrical retainer mechanism.

2. The dental polishing system of claim 1 wherein the at least two projection mechanisms and the rim of the substantially cylindrical retainer mechanism comprise an abrasive composition.

3. The dental polishing system of claim 2 further comprising at least one divider mechanism extending radially inward from an interior portion of the upper portion of the substantially cylindrical retainer mechanism.

4. The dental polishing system of claim 1 wherein the median portion and the lower portion of the substantially cylindrical retainer mechanism are substantially flexible.

5. The dental polishing system of claim 1 wherein the lower portion of the actuation mechanism comprises an area for communication with a rotary motion mechanism.

6. The dental polishing system of claim 1 wherein the substantially cylindrical retainer mechanism comprises a plurality of abrasive members attached to an inner portion of the substantially cylindrical retainer mechanism.

7. The dental polishing system of claim 1 wherein the at least two projection mechanisms are attached to the upper portion of the actuation arm.

8. The dental polishing system of claim 1 wherein the substantially cylindrical retainer mechanism comprises an abrasive composition positioned within the substantially cylindrical retainer mechanism.

9. The dental polishing system of claim 1 wherein the at least one divider mechanism is substantially triangular.

10. The dental polishing system of claim 1 wherein the at least two projection mechanisms comprise at least one groove shape for retaining polishing mixtures.

11. The dental polishing system of claim 10 wherein the at least one groove shape for retaining polishing mixtures may be selected form the group consisting of a square, an internal rectangle, a triangle and a round.

12. The dental polishing system of claim 1 wherein the at least one divider mechanism comprises a range of two to ten dividers.

13. The dental polishing system of claim 1 wherein the at least two projection mechanisms comprise a range from three to twenty projection mechanisms.

14. A dental polishing apparatus comprising:
a cup mechanism, comprising an upper portion, a median portion and a lower portion, wherein the upper portion comprises a substantially rigid rim portion;
at least two finger mechanisms in mechanical communication with the cup mechanism, wherein the at least two finger mechanisms extend upward from the lower portion of the cup mechanism wherein the at least two finger mechanisms extend substantially flush with the rim of the cup mechanism wherein the at least two finger mechanisms are flexible to follow surface contours simultaneously with said rim during use; and,
at least one wing mechanism extending radially inward from an interior portion of the upper portion and middle portion of the cup mechanism; and,
an attachment arm in communication with the cup wherein the attachment arm extends through the lower portion of the cup.

15. The dental polishing apparatus of claim 14 wherein the median portion and the lower portion of the cup mechanism are substantially flexible.

16. The dental polishing apparatus of claim 14 wherein the lower portion of the attachment arm comprises an area for communication with a rotary motion mechanism.

17. The dental polishing apparatus of claim 14 wherein the cup mechanism comprises a plurality of abrasive members attached to an inner portion of the cup mechanism.

18. The dental polishing apparatus of claim 14 wherein the at least two finger mechanisms are attached to the upper portion of the attachment arm.

19. The dental polishing apparatus of claim 14 wherein the cup mechanism comprises an abrasive composition positioned within the cup mechanism.

20. The dental polishing system of claim 14 wherein the at least two finger mechanisms comprise at least one groove shape for retaining polishing mixtures.
